(19) United States
(12) Patent Application Publication
(10) Pub. No.: US 2010/0163786 A1
(43) Pub. Date: Jul. 1, 2010

(54) Polishing composition for semiconductor wafer

(76) Inventors: Masahiro Izumi, Tokyo (JP); Masaru Nakajo, Tokyo (JP); Yukiyo Saito, Tokyo (JP); Kuniaki Maejima, Tokyo (JP); Hiroaki Tanaka, Ayase-shi (JP)

Correspondence Address: FLYNN THIEL BOUTELL & TANIS, P.C., 2026 RAMBLING ROAD, KALAMAZOO, MI, 49008-1631, US

(21) Appl. No.: 12/653,683

(22) Filed: Dec. 17, 2009

(30) Foreign Application Priority Data
Dec. 25, 2008 (JP) 2008-330548

(51) Int. Cl. C09K 13/00

(52) U.S. Cl. 252/79.1

(57) ABSTRACT

A polishing composition for semiconductor wafer polishing comprising, colloidal silica prepared from an active silicic acid aqueous solution obtained by removal of alkali from alkali silicate and at least one nitrogen containing basic compound selected from a group consisting of ethylenediamine, diethylenediamine, imidazole, methylimidazole, piperidine, morpholine, arginine, and hydrazine, wherein pH of the colloidal silica is of 8.5 to 11.0 at 25° C. by containing quaternary ammonium hydroxide.

### FIELD OF THE INVENTION

The present invention relates to polishing composition for semiconductor wafer that polishes a surface or an edge part of a semiconductor wafer such as a silicon wafer or a semiconductor device substrate with a film such as a metal film, an oxide film, a nitride film or the like (hereinafter shortened to metal films) on the surface.

Hereinafter, “polishing composition for semiconductor wafer” can be shortened to “polishing composition”.

### BACKGROUND OF THE INVENTION

Electronic components such as ICs, LSIs or ULSIs which applying semiconductor materials, such as silicon single crystal, as raw material can be manufactured based on a small semiconductor device chips. Said small semiconductor device chips are fabricated by dicing thin disk shaped wafers on which a number of fine electronic circuits are built to semiconductor chips, where the wafers are fabricated by slicing a single crystal ingot of silicon or semiconductors of other compound to thin disk shaped wafers. A wafer sliced from the ingot is processed into a mirror wafer with a mirror finished surface and edge through the processes of lapping, etching, and polishing. In following device manufacturing process, fine electric circuits are formed on the mirror finished surface of the wafer. At present, from the view point of developing high speed LSIs, material for wiring has changed from conventional Al to Cu, which is characterized to have lower electric resistance. Also an insulation film existing between wirings has changed from a silicon oxidation film to a low permittivity film which is characterized to have lower permittivity. Further, for the purpose of protecting the diffusion of Cu into the low permittivity film, a wiring forming process is shifting to a new process that interposing a barrier film which is made from tantalum or tantalum nitride between Cu and the low permittivity film. According to such a circuit structure formation and a high integration requirement, a polishing process is carried out frequently and repeatedly to planarize the interlayer insulation film, to form a metal plug between upper and lower wirings, to form an embedded wiring or the like. Generally, the polishing step is processed by rotating the semiconductor wafer which is placed on and pressed against a platen on which a polishing cloth made from synthetic resin foam, suede-like synthetic leather or the like is applied, while a quantitative amount of polishing compound solution is supplied so as to polish the semiconductor wafer.

On the edge surface of the wafer, above mentioned metal films or the like are disorderly accumulated. Before dicing the wafer to semiconductor device chips, various wafer transportation processes exist. The wafer is supported at the edge when it is a subject to the transportation and the like while keeping an initial disk shape. If outermost periphery edge of the wafer is unevenly structured at the transportation, minute crushes are caused at the edge part of the wafer when the wafer collides with a transporting device and fine particles will arise. The fine particles arisen will scatter and contaminate the precisely processed wafer surface, and affect seriously on the yield and the quality of products. To prevent the contamination by the fine particles, the edge part of the semiconductor wafer is required to have a mirror polishing process after the metal films or the other are formed.

Above mentioned edge polishing is performed by a method mentioned below. First, an edge part of a semiconductor wafer is pressed against a polishing machine which has a polishing cloth supporter, on which a polishing cloth made from synthetic resin foam, synthetic leather, nonwoven fabric or the like is applied. Then, the polishing cloth supporter and/or the wafer are rotated while a polishing compound solution which containing polishing particles, such as silica, as a main component is supplied. As the polishing particles to be contained in said polishing compound, one can use colloidal silica which is similar to the one used for edge polishing of a silicon wafer, fumed silica, cerium oxide or alumina that is used for surface polishing of a device wafer, or the like. Especially, colloidal silica and fumed silica claim attention because both silica are fine particles and smooth mirror surface can be easily obtained. The polishing compound mentioned above is also called as “slurry”, which may be called as such in some cases below.

In general, a polishing compound which containing silica particles as main components is given as a solution that contains alkaline components. The polishing mechanism can be described as a combination of a chemical action by the alkaline components, specifically, chemical corrosion of a surface of silicon oxide films, metal films, and the like by the alkaline components, and a mechanical polishing action by silica particles. More specifically, by the corrosive action by the alkaline components, thin and soft eroded layer is formed on a surface of an object to be polished such as a wafer. Said eroded layer is removed by the mechanical polishing action by fine polishing particles. By repeating said actions, the polishing process will be progressed.

Further, device wiring is becoming remarkably finer and more precise year by year. According to “International Technology Roadmap for Semiconductors”, target width of device wiring is 50 nm in 2010 and 35 nm in 2013. Considering finer tendency of width of device wiring, copper or copper alloy has become in use as a wiring material. As a polishing compound to be used for semiconductor polishing, oxidative components of copper or selective etching components other than alkaline components are recommended. Especially, amines claim attention as an agent that seldom over etches a wafer, however, a problem has not been solved. Since over etching of device wiring on the semiconductor wafer surface inhibits an operation of a device, it is a serious problem.

Up to the present, various polishing compounds have been proposed for mirror polishing of semiconductor wafers. In Patent Document 1, a polishing compound prepared by dispersing silica in ethylenediamine or hydrazine is disclosed. According to the document, said polishing compound can polish polysilicon at high rate while it seldom etches a silicon oxide insulation film, and providing an advantage that one can use the insulation film as a stopper. In Patent Document 2, a polishing compound prepared by dispersing polishing particles in an imidazole aqueous solution or a methylimidazole aqueous solution is disclosed. According to the document, said polishing compound forms a copper complex which is water soluble and never produces water insoluble solid matter other then polishing particles. Therefore, said polishing compound can prevent scratches and can also prevent dishing because it controls etching of a copper oxide layer. In Patent Document 3, a polishing compound prepared by adding diethylenediamine or piperidine to colloidal silica is disclosed. Said amines act as a weak base component aiming to form a pH buffer solution. In Patent Document 4, a polishing compound containing amino acid which possessing 2 or more nitrogen atoms in a molecular structure, such as arginine, is disclosed. According to the document, said polishing compound has high polishing rate against a copper film, while has low polishing rate against a compound containing tantalum, and is characterized to have excellent selection ratio.

As disclosed in above mentioned Patent Documents 1 to 4, ethylenediamine, diethylenediamine, imidazole, methylimidazole, piperidine, arginine, and hydrazine are useful agents among nitrogen containing basic compounds for metal polishing. Regarding morpholine, adequate Patent Document could not be found out. Diethylenediamine is also called as piperazine.

Further, many types of colloidal silica composed of nonspherical silica particles are proposed. In Patent Document 5, a stable silica sol which prepared by dispersing amorphous colloidal silica particles into a liquid solvent is disclosed. Said amorphous colloidal silica particles are elongated shaped silica that have uniformed thickness of 5 to 40 nm by an electron microscope observation and extend only in two dimensional. In Patent Document 6, a silica sol composed of amorphous and elongated colloidal silica particles is disclosed. Said silica sol is prepared by growing metal compounds such as aluminum salt before, in the middle or after an adding process of silica. In Patent Document 7, a colloidal silica composed of cocoon shaped silica particles whose long axis/short axis ratio is in range of 1.4 to 2.2 and which produced by hydrolysis of alkoxysilane is disclosed. In Patent Document 8, a production method of colloidal silica containing nonspherical silica particles by using a hydrolysis solution of alkoxysilane instead of an active silicic acid aqueous solution of water glass method and tetraalkylammonium hydroxide as an alkali agent is disclosed.

In a production process of colloidal silica mentioned in Patent Document 5, there is an adding process of water soluble calcium salt, magnesium salt or mixture of salts, which is contained in a product as impurities. In a production process of colloidal silica mentioned in Patent Document 6, there is an adding process of water soluble aluminum salts, which is contained in a product as impurities. Colloidal silica mentioned in Patent Document 7 is desirable because of its high purity according to the fact that using alkoxysilane as a silica source. However, ammonia and large amount of alcohol are required in a reaction system which arises disadvantages such as difficulty in removal of the components, price, and so on. Similarly, since colloidal silica mentioned in Patent Document 8 also uses alkoxysilane as a silica source, it is also high in purity and is desirable. One can produce said silica particles within nonspherical shape, however, technical investigation about adjustment of particle shape is not sufficient.

In Patent Document 9, the colloidal silica comprising a buffer solution composed of mixing a weak acid which have a pKa (a logarithm of a reciprocal of acid dissociation constant) of 8.0 to 12.0 at 25° C. and a strong base, wherein the composition displays a buffering action in the pH range of 8.7 to 10.6 at 25° C. is disclosed. However, since said colloidal silica contains alkali metal, the colloidal silica cannot meet with requirement of resent years for polished surface, further, in the Patent Document, shape of colloidal silica is not referred at all.

Patent Document 1 JPH2-146732 A publication

Patent Document 2 JP2005-129822 A publication

Patent Document 3 JPH11-302635 A publication

Patent Document 4 JP2002-170790 A publication

Patent Document 5 JPH1-317115 A publication (especially in claims)

Patent Document 6 JPH4-187512 A publication

Patent Document 7 JPH11-60232 A publication (especially in claims)

Patent Document 8 JP2001-48520 A publication (especially in claims and in Examples)

Patent Document 9 JPH11-302634 A publication

### DISCLOSURE OF THE INVENTION

### Object of the Invention

The present invention relates to a colloidal silica for mirror polishing of a surface or an edge part of a semiconductor wafer, which prevents over etching of the semiconductor wafer surface while maintaining high polishing rate and providing satisfactory surface roughness, and the production method thereof.

### BRIEF SUMMARY OF THE INVENTION

The inventors of the present invention have found that one can polish a surface or an edge part of a semiconductor wafer effectively by using colloidal silica which produced from an active silicic acid aqueous solution obtained by removal of alkali from alkali silicate and specific nitrogen containing basic compounds, and by using colloidal silica containing quaternary ammonium hydroxide, and accomplished present invention.

The first invention of the present invention is a colloidal silica for semiconductor wafer polishing prepared from an active silicic acid aqueous solution obtained by removal of alkali from alkali silicate and at least one nitrogen containing basic compound selected from a group consisting of ethylenediamine, diethylenediamine, imidazole, methylimidazole, piperidine, morpholine, arginine, and hydrazine, wherein pH of the colloidal silica is of 8.5 to 11.0 at 25° C. by containing quaternary ammonium hydroxide. As the quaternary ammonium hydroxide, tetramethylammonium hydroxide, tetraethylammonium hydroxide or choline hydroxide is desirable.

The second invention of the present invention is the colloidal silica for semiconductor wafer polishing prepared from said nitrogen containing basic compound further comprising, a buffer solution composed of mixing a weak acid which have a pKa (a logarithm of a reciprocal of acid dissociation constant) of 8.0 to 12.0 at 25° C. and quaternary ammonium hydroxide, wherein said colloidal silica for semiconductor wafer polishing displays a buffering action in the pH range of 8.5 to 11.0 at 25° C. As the quaternary ammonium hydroxide, tetramethylammonium hydroxide, tetraethylammonium hydroxide or choline hydroxide are desirable. As the weak acidic ion, a carbonate ion and/or a hydrogen carbonate ion are desirable.

In the first and second invention, it is desirable that the colloidal silica contains non-spherical particles which have an average short axis length of 10 to 30 nm, long axis/short axis ratio of 1.1 to 20, and average long axis/short axis ratio of 1.2 to 7, by electron microscopic observation method. In the same way, it is desirable that the average particle diameter of silica particles is of 10 to 50 nm by nitrogen adsorption BET method.

In the first and second invention, it is desirable that the polishing compound is water dispersion whose concentration of silica to entire colloidal silica solution is of 2 to 50 weight %. Also, it is desirable that the concentration of alkali metal to entire solution of colloidal silica is less than 100 ppm.

### BRIEF ILLUSTRATION OF THE DRAWINGS

FIG. 1: TEM observation picture of colloidal silica obtain in Preparation Example 1.

FIG. 2: TEM observation picture of colloidal silica obtain in Preparation Example 2.

FIG. 3: TEM observation picture of colloidal silica obtain in Preparation Example 3.

FIG. 4: TEM observation picture of colloidal silica obtain in Preparation Example 4.

FIG. 5: TEM observation picture of colloidal silica obtain in Preparation Example 5.

FIG. 6: TEM observation picture of colloidal silica obtain in Preparation Example 6.

FIG. 7: TEM observation picture of colloidal silica obtain in Preparation Example 7.

FIG. 8: TEM observation picture of colloidal silica obtain in Preparation Example 8.

### EFFECT OF THE INVENTION

By using the polishing composition of present invention, one can obtain excellent effect in preventing over etching in polishing of a semiconductor wafer and the like. “Over etching” is a phenomenon that causes by corrosion of a wiring metal which results formation of recesses during polishing process of the wiring metal, an insulation film or a barrier film. Over etching occurs when a balance of corrosive speed between a mechanical polishing action by polishing particles and a corrosive action by alkaline component is broken. Over etching is recognized as a ground of defective products such as corrosive pits, wiring corrosions or key holes of tungsten wiring. Further, since said polishing composition does not contain alkali metals, problems such as remaining of polishing particles or dispersion of alkali metal to wiring layer can be prevented. So, the present invention has great influence to the relating field.

### DESCRIPTION OF THE PREFERRED EMBODIMENT

As mentioned above, nitrogen containing basic compounds are the useful agents in metal polishing and are disclosed in many Patent Documents. On the other hand, polishing composition for semiconductor wafer polishing comprising, colloidal silica prepared from an active silicic acid aqueous solution obtained by removal of alkali from alkali silicate and at least one nitrogen containing basic compound selected from a group consisting of ethylenediamine, diethylenediamine, imidazole, methylimidazole, piperidine, morpholine, arginine, and hydrazine, is a new invention by the inventors of the present invention. And the fact that said colloidal silica can display great polishing ability while polishing a subject such as silicon wafer or the like is first shown in the present invention. Said polishing composition of the present invention can prevent over etching according to its close-neutral pH in spite of the alkali amount, can keep adequate polishing ability according to nonspherical shape of silica, and can keep the polishing ability according to existence of buffer solution.

Ethylenediamine is a strong base whose pKa is of about 9.9 and a pH of a 1% aqueous solution is about 11.8. There are two sorts of ethylenediamine: ethylenediamine anhydride and ethylenediamine mono hydrate. Ethylenediamine mono hydrate is preferred because it is less dangerous agent. Another name of diethylenediamine is piperazine and is also known as hexahydropyrazine or diethyleneimine. There are two sorts of diethylenediamine: diethylenediamine anhydride and diethylenediamine hexahydrate. Diethylenediamine hexahydrate is easier to use. Diethylenediamine is a strong base whose pKa is about 9.8 and a pH of a 1% aqueous solution is about 11.5. Imidazole is a weak base whose pKa is about 6.9 and a pH of a 1% aqueous solution is about 10.2. 2-methylimidazole is a weak base whose pKa is about 7.8 and a pH of a 1% aqueous solution is about 10.7. 4-methylimidazole can also be used instead of 2-methylimidazole. Other names of piperidine are hexahydropyridine and pentamethyleneimine. Piperidine is a strong alkali whose pKa is about 11.1 and a pH of a 1% aqueous solution is about 12.3. Morpholine is a slightly weak base whose pKa is about 8.4 and a pH of a 1% aqueous solution is about 10.8. Arginine is one of amino acids which also known as 5-guadidino-2-amino pentanoic acid and is a base whose pKa is about 12.5 and a pH of a 1% aqueous solution is about 10.5 because it possesses a carboxy group. Although each of D-, L- or DL-arginine can be used, L-arginine is preferably used among three because of low price. There are two sorts of hydrazine: hydrazine anhydrous and hydrazine monohydrate (also known as hydrohydrazine or hydrazine hydrate). Hydrazine monohydrate is preferred because it is less dangerous agent. Hydrazine is a strong reducing agent, however, as a base, it is a weak base whose pKa is about 8.1 and a pH of a 1% aqueous solution is about 9.9.

It is desirable that any kind of above mentioned nitrogen containing basic compounds do not contain alkali metals. Since any kind of said nitrogen containing basic compounds except arginine has strong irritative feature, toxicity, and corrosive feature, it is desirable to be used as an aqueous solution of about 10% concentration.

Above mentioned nitrogen containing basic compounds act as a polymerization catalyst of silica of an active silicic acid aqueous solution due to its basic feature. That is, colloidal particles can be obtained by heating the active silicic acid aqueous solution after alkalizing the solution by adding said nitrogen containing basic compounds. In the meanwhile, said nitrogen containing basic compounds affect particle form at a growing process of colloidal particles. Said nitrogen containing basic compounds bond with or adsorbs to surfaces of silica particles in the growing process and inhibits growing of particles at bonded parts and disturbs spherical growing of particles.

In the present invention, for the purpose of maintaining a stable polishing ability at actual polishing processes, it is desirable to maintain a solution at a pH of 8.5 to 11.0 at 25° C. When the pH is lower than 8.5, polishing rate becomes slow and is out of practical use. Further, when the pH is higher than 11.0, the solution over etches nonpolishing parts of a wafer and deteriorates a flatness of the wafer and is also out of practical use.

Further, it is desirable that a pH of the solution does not change easily by exterior conditions such as abrasion, heating, contacting with outer atmosphere, mixing with other components or the like. Especially, in a case of edge polishing, a polishing compound is used by a circulation flow. That is, the polishing compound supplied from a slurry tank to polishing parts sent back to the slurry tank so that to be reused. In a case of a polishing compound that contains an alkalizing agent alone, a pH of the solution falls in short time since the solution is diluted with pure water used in the circulation flow. The phenomenon is caused by influx of pure water, which is used as cleaning water. Alternation of the pH affects a polishing rate, and lack of polishing or over polishing is easily caused.

For the purpose of maintaining a pH of polishing composition of the present invention, it is desirable that polishing composition has a buffer function in a pH range of 8.5 to 11.0. Therefore, in the present invention, it is desirable to make polishing composition itself a strong buffer solution that does not change a pH dramatically according to exterior conditions. To form a buffer solution, a method of blending a buffer composed of mixing a week acid and a strong base can be mentioned. For example, a method of adding carbonated tetraalkylammonium aqueous solution which prepared by neutralizing tetraalkylammonium hydroxide aqueous solution with carbon dioxide gas to adjust pH of 8.5 to 11.0 to colloidal silica can be mentioned. Further, as another method, a method of adding a buffer solution prepared by mixing a tetraalkylammonium hydroxide aqueous solution and a tetraalkylammonium hydrogencarbonate aqueous solution by optional compounding to adjust pH of 8.5 to 11.0 to colloidal silica can be mentioned.

An active silicic acid aqueous solution used in the present invention is obtained by removal of alkali from a silicic alkali aqueous solution by using cation exchange resin. For a silicic alkali aqueous solution, sodium silicate aqueous solution called “water glass (water glass number 1 to 4 or the like)”, are generally used as raw material. This is comparably inexpensive and easy to obtain. Also a potassium silicate aqueous solution fits to the need since semiconductors dislike the contamination by Na ion. There is another way to obtain a silicic alkali aqueous solution, such as the way to dissolve metasilicate alkali solid to water. There is less contaminated metasilicate alkali solid since it requires crystallization process to obtain. One can dilute a silicic alkali aqueous solution with water by their need.

One can use any public known ion-exchange resin in the present invention. For example, one can accomplish a contacting process of a silicic alkali aqueous solution and cation-exchange resin by following induction. First, dilute a silicic aqueous solution with water so that to adjust SiO₂ concentration of dilution of 3 to 10 weight %. Then acid can be removed by contacting with H type strong acid cation-exchange resin. One can use OH type strong basic anion-exchange resin after above mentioned process by the need. By processing the inductions mentioned above, one can obtain an active silicic aqueous solution. One can use any public known ways and rules to contact solution to resin.

A production method of colloidal silica of the present invention can be illustrated as follows. First, an active silicic acid aqueous solution is prepared. Next, nitrogen containing basic compounds are added to the said active silicic acid aqueous solution so as to alkalize the solution. Then, colloidal particles are formed by heating the solution (a seed particles forming process). At the end, above mentioned active silicic acid aqueous solution and an alkalizing agent or above mentioned active silicic acid aqueous solution, the nitrogen containing basic compounds, and the alkalizing agent are added to the colloidal solution formed in the previous process while maintaining in alkaline condition under heating condition to grow colloidal solution (a particles growing process). At the seed particles forming process, the nitrogen containing basic compounds are used, however, at the particles growing process, use of the alkalizing agent alone is possible. As the alkalizing agent, one needs to use quaternary ammonium hydroxide.

Specifically, in above mentioned seed particles forming process and particles growing process, conventional operations are used. For example, seed particles whose short axis length (thickness) is of 10 to 30 nm can be formed as follows. First, silica concentration of an active silicic acid aqueous solution is set to 2 to 7 weight %. By adding nitrogen containing basic compounds, a pH of the solution is adjusted to 8 to 11. The solution is heated to the temperature of 60 to 240° C. to obtain said seed particles. Said seed particles can be grown to silica particles whose short axis length (thickness) is of 10 to 150 nm using a build up method. That is, the method of adding an active silicic acid aqueous solution and an alkalizing agent or the active silicic acid aqueous solution, nitrogen containing basic compounds, and the alkalizing agent to the colloidal solution of said seed particles whose pH is of 8 to 11 and temperature is of 60 to 240° C. The process is carried out while maintaining the solution at the pH of 8 to 11.

As the alkalizing agent used in the particles growing process, quaternary ammonium hydroxide is desirably used, and in particular, tetramethylammonium hydroxide, tetraethylammonium hydroxide or choline hydroxide are more desirable. Said organic alkalizing agent is preferred not to contain alkali metals.

As the next process, concentration of silica by ultra-filtration is carried out. Concentration by water evaporation can also be used, however, ultra-filtration is more advantageous from the view point of energy consumption.

An ultra-filtration membrane to be used at the concentration process of silica by ultra-filtration can be illustrated as follows. Separation which uses the ultra-filtration membrane is objecting particles with size of 1 nm to several microns. Since dissolved polymer product is also being objected, filtration accuracy is indicated by molecular weight cut off (hereinafter referred to as “MWCO”) in nano-meter region. In the present invention, an ultra-filtration membrane whose MWCO is smaller than 15000 is desirably used. By using the ultra-filtration membrane of said range, particles larger than 1 nm can be separated. More desirably, an ultra-filtration membrane whose MWCO is 3000 to 15000 is used. When ultra-filtration membrane whose MWCO is smaller than 3000 is used, filtration resistance becomes too high and disadvantageous from economical view point, and when MWCO is over 15000, purification accuracy is deteriorated. As a material of a membrane, polysulfone, polyacrylonitrile, sintered metal, ceramics, carbon or the like can be used, however, from the view point of heat resistance and filtration speed, a membrane made from polysulfone is preferable and easier to use. As a shape of the membrane, any kinds of shapes, such as spiral shape, tubeler shape, hollow filament shape or the like can be used. However, among said shapes, hollow filament shape is preferable because it is compact and easier to use. Further, when the ultra-filtration process acts concurrently as washing and removing process of excess nitrogen containing basic compounds, it is possible to improve removing rate by adding pure water even after reaching the aimed concentration. Furthermore, it is also desirable to remove strong acid anion which added as a catalyst of hydrolysis. It is desirable to concentrate silica so as the concentration of silica to be of 10 to 50 weight %.

Further, before or after an ultra-filtration process, a purification process by ion-exchange resin can be added if necessary. For example, above mentioned strong acid anion can be removed by contacting with OH type strong basic anion-exchange resin.

Nitrogen containing basic compounds dissolved in water phase diminish together with water at concentration process by ultra-filtration. When the amount of nitrogen containing basic compounds became too small, it is desirable to supply the compound after concentration process.

However, existence of an organic compound may cause secondary problem in a liquid-waste treatment process. Considering such a case, a product from which nitrogen containing basic compounds is removed is also required. A method of reducing the amount of the nitrogen containing basic compounds as possible by using ultra-filtration effectively is involved in the present invention as one of the production method.

Colloidal silica forming nonspherical particles cluster is characterized to have a shape similar to a caterpillar or a bended rod. Each particle has a different shape, and specifically, said colloidal silica contains silica particles having a shape shown in FIGS. 1 to 8. Long axis/short axis ratio of the colloidal silica is within the range of 1.1 to 20. The most part of the particles are not extended straightly, and non-extended particles are partially existed. Only a few silica particles are shown in FIGS. 1 to 8 as examples, although shapes are changeable by producing conditions, nonspherical shaped ones are major.

Average long axis/short axis ratio of silica particles of the colloidal silica for polishing of the present invention is within the range of 1.2 to 7 which is suited as polishing particles. If the ratio is larger than 7, the particles intertwine with each other, and if the ratio is smaller than 1.2, the polishing rate drops.

In a polishing process, a shape of silica particles is a very important factor. That is, by a corrosive action of alkaline, a thin eroded layer is formed on a surface of an object to be polished, and removal rate of the thin layer is changed largely by the shape of particles. When the size of silica particles becomes larger, the removal rate increases. However, scratches are formed easily on the polished surface. And, non-spherical particles promises larger removal rate compare to spherical shaped particles, however, scratches are formed easily on the polished surface. Therefore, it is desirable that the particles have an adequate size and shape, and the particles must not be crushed easily or agglomerate to form gel.

A shape of the silica particles of the colloidal silica for polishing of the present invention is very similar to the shape of fumed silica. Silica particles of fumed silica generally form nonspherical elongated particles cluster whose long axis/short axis ratio is of 5 to 15. Primary particle size of fumed silica (can be simply described as particle size) indicates short axis length (thickness) and is normally 7 to 40 nm. Further, these particles agglomerate and form secondary particles and appearance of slurry is white. Therefore, when the slurry of fumed silica is preserved for long time, particles tend to precipitate and cause scratches on the polished surface.

On the contrary, although silica particles of the present invention have similar shape to primary particles of fumed silica, silica particles do not form secondary particles by agglomeration, and appearance of slurry is transparent or semi-transparent. Particles do not have tendency to precipitate and do not cause scratches on the polished surface.

Desirable average short axis length of silica particles of the colloidal silica for polishing composed of silica particles of the present invention is of 10 to 30 nm by an electron micrometer observation, and concentration of silica particles is of 2 to 50 weight %. When average short axis length of silica particles is smaller than 10 nm, polishing rate is low and stability of colloid is lacked because particles easily agglomerate. Further, when average short axis length is larger than 30 nm, scratches are easily caused and flatness of the polished surface deteriorates.

The present invention can provide a polishing compound that containing above mentioned colloidal silica for polishing and further, components that can further improve polishing ability are added.

In the present invention, polishing rate can be remarkably improved by elevating the electric conductivity value of the polishing compound solution. Electric conductivity is an index value of conduction of electricity, and indicated by a reciprocal number of electric resistance per unit length. In the present invention, electric conductivity is indicated as converted number of electric conductivity (milli-Siemens) to 1 weight % of silica. In the present invention, when electric conductivity at 25° C. is larger than 15 mS/m/1%-SiO₂, it is desirable to improve the polishing rate, and larger than 20 mS/m/1%-SiO₂ is more desirable. Since addition of salts deteriorates stability of colloid, upper limit for amount of salts addition does exist. Upper limit is changeable according to particle size of silica, however, is approximately 60 mS/m/1%-SiO₂.

As a method to elevate an electric conductivity, following two methods can be mentioned. One is to elevate concentration of a buffer solution and another one is to add salts. To elevate concentration of the buffer solution, one can elevate only concentration of weak acid and quaternary ammonium hydroxide without changing a molar ratio. Salts used for the method of adding salts are composed of acid and base mixture, and as an acid, both strong and weak acid can be used. Mineral acid, organic acid or mixture of these acids can also be used. As a base, use of water soluble quaternary ammonium hydroxide is desirable.

As a salt composed by strong acid and quaternary ammonium base, it is desirable to use at least one of the compounds selected from the group consisting of quaternary ammonium sulfate, quaternary ammonium nitrate, and quaternary ammonium fluoride. As a quaternary ammonium hydroxide, tetramethylammonium hydroxide, tetraethylammonium hydroxide or choline hydroxide are desirable.

A polishing compound containing colloidal silica for polishing of the present invention is desirable to contain a chelating agent that forms a water insoluble chelate compound with copper. For example, as said chelating agent, public known compounds like azoles, such as benzotriazole, or quinoline derivatives, such as quinolinol or quinaldinic acid, are desirably used.

For the purpose of improving the feature of said polishing composition for polishing, surfactant, a water soluble polymer compound or a deforming agent can be used together with.

As a surfactant, nonionic surfactant is desirably used. Nonionic surfactant has a function to protect excess etching. For example, polyoxyalkylenealkylether, such as polyoxyethylenelaurylether, fatty acid ester, such as glycerinester, or polyoxyalkylenealkylamine, such as di(polyoxyethylene)laurylamine, can be used. Preferable concentration of nonionic surfactant contained in a polishing compound containing colloidal silica for polishing is of 0.001 to 0.1 weight %.

As a water soluble polymer compound, at least one of the compounds selected from the group consisting of hydroxyethyl cellulose, polyethylene glycol or polyvinylalcohol is desirable. These compounds have a protecting effect for excess etching. Ethyleneoxide-propyleneoxide tri-block copolymer is also desirably used. For example, when hydroxyethyl cellulose is used, it acts as a water soluble polymer in the concentration range of 30 to 300 ppm when it is added to the 1 to 100 diluted polishing compound. Therefore, required concentration of hydroxyethyl cellulose in an original polishing compound is of 0.3 to 3 weight %. In the same way, in a case of polyethyleneglycol, required concentration is of 0.3 to 5 weight %, and in a case of polyvinylalcohol, required concentration is of 0.1 to 5 weight %.

As a defoaming agent, silicone emulsion is desirably used. As silicone emulsion, silicone defoaming agent being on the market, which is O/W type emulsion of silicone oil mainly composed of polydimethylsiloxane can be used. Concentration of defoaming agent in polishing compound is of 0.01 to 0.1 weight %.

A polishing compound containing colloidal silica for polishing of the present invention is said as an aqueous solution, however, an organic solvent can be added. Other abrasives, such as colloidal alumina, colloidal ceria or colloidal zirconia, bases, additives or water can be mixed with said polishing compound of the previous invention during a producing process.

Regarding the polishing compound containing colloidal silica for polishing of the present invention, it is desirable to produce with silica concentration of 20 to 50 weight %, and dilution is carried out with pure water at actual use. A pH adjusting agent or salts for adjusting an electric conductivity is added if it is required.

### EXAMPLES

The present invention will be illustrated in more detail in Examples, although, these examples will not limit the previous invention. In Examples, following equipments are used for analysis of colloidal silica.

(1) TEM observation: Transmission Electron Microscope H-7500 of Hitachi Ltd., is used.

(2) Specific surface area by BET method: Flow Sorb 2300 of Shimadzu Corporation is used.

(3) Analysis of nitrogen containing basic compounds except hydrazine: Total organic carbon meter TOC-5000A, SSM-5000A of Shimadzu Corporation is used. Carbon amount is converted into nitrogen containing basic compounds. Specifically, total organic carbon amount (TOC) is calculated by numerical formula of TOC=TC−IC after total carbon amount (TC) and inorganic carbon amount (IC) are measured. As a standard for TC measurement, a glucose aqueous solution of 1 weight % carbon amount is used, and as a standard for IC measurement, sodium carbonate of 1 weight % carbon amount is used. Ultrapure water is used as a standard of 0 weight % carbon amount. By using above mentioned standards, calculation curves of 150 μL and 300 μL for TC and of 250 μL for IC are prepared. At TC measurement, 100 mg of specimen is picked and burned in a combustion furnace of 900° C. And at IC measurement, 20 mg of specimen is picked, and about 10 mL of (1+1) phosphoric acid are added. The reaction is accelerated in a combustion furnace of 200° C.

(4) Analysis of hydrazine: Absorptiometer UV-VISIBLE RECORDING SPECTRO PHOTOMETER UV-160 of Shimadzu Corporation is used. Measurement is carried out according to p-dimethylbenzaldehyde absorption method regulated in JIS B8224. Specifically, specimen is acidized by hydrochloric acid, followed by addition of p-dimethylbenzaldehyde, to obtain a yellowish compound. Absorbancy of the yellowish compound is measured and hydrazinium ion is quantitated. From the obtained value of hydrazinium ion, concentration of hydrazine is calculated.

(5) Analysis of metal elements: ICP emission spectrometry ULTIMA 2 of Horiba, Ltd. is used.

### Examples and Comparative Examples

Preparation Examples of Colloidal Silica Used in Examples (Preparation Examples 1 to 8) and Comparative Examples (Preparation Examples 9 and 10 and colloidal silica on the market) are illustrated in detail below. As a colloidal silica on the market 1 used in Comparative Examples, a colloidal silica on the market (“SILICADOL 40L” product of Nippon Chemical Industrial Co. Ltd., having particle size of 21 nm, concentration of silica of 40%, content of Na of 4000 ppm) is used. As a colloidal silica on the market 2 used in Comparative Examples, a colloidal silica on the market (“SILICADOL 40G” product of Nippon Chemical Industrial Co., Ltd., having particle size of 50 nm, concentration of silica of 40%, content of Na of 3000 ppm) is used.

### Preparation Example 1

5.2 kg of JIS 3 sodium silicate (SiO₂: 28.8 weight %, Na₂O: 9.7 weight %, H₂O: 61.5 weight %) is added to 28 kg of deionized water, then mixed homogeneously and diluted sodium silicate having silica concentration of 4.5 weight % is prepared. This diluted sodium silicate is passed through a column containing 20 L of H type strong acidic cation exchange resin (AMBERLITE IR120B, product of ORGANO CORPORATION), which is previously regenerated by hydrochloric acid, and 40 kg of an active silicic acid aqueous solution having SiO₂ concentration of 3.7 weight % and a pH of 2.9 is obtained. On the other hand, ethylenediamine anhydride (reagent) is added to deionized water and 10 weight % ethylenediamine aqueous solution is prepared.

Then, colloidal particles are grown up by a build up method. That is, 16 g of 10 weight % ethylenediamine aqueous solution is added to 500 g of said obtained active silicic acid aqueous solution while it is stirring and the pH is adjusted to 8.5. The solution is heated to 98° C. and preserved 1 hour, then 7.6 kg of active silicic acid aqueous solution is added by 16 hours. During adding process, 10 weight % ethylenediamine aqueous solution is added so as to maintain the pH of 9 to 10, while heating (98° C.) is continued. Heating (98° C.) is continued 1 hour after adding process is over, then the solution is matured, and cooled down. According to evaporation of water during adding process, 7.46 Kg of colloidal silica is obtained after cooled down which has a pH of 9.7.

After that, pressure filtration by pump circulation using hollow fiber ultrafilter membrane whose molecular cutoff value is 6000 (MICROZA UF MODULE SIP-1013, product of ASAHI KASEI Corp.) is carried and the solution is concentrated to have silica concentration of 23 weight % and approximately 1.35 kg of colloidal silica is recovered. Particle size measured by BET method of this colloidal silica is of 18.6 nm, and according to a transmission electron microscope (TEM) observation, it is understood that the colloidal silica forms nonspherical particle cluster, wherein average short axis length is approximately of 20 nm and long axis/short axis ratio is of 1.5 to 7, and average long axis/short axis ratio is of 5. Content of ethylenediamine is of 0.258 weight % and sodium content and potassium content are respectively 30 ppm and 0 ppm. By use of ethylenediamine, colloidal silica of lower content of alkali metal can be obtained. TEM observation of silica particles is shown in FIG. 1.

### Preparation Example 2

By same method as Preparation Example 1, 40 kg of an active silicic acid aqueous solution having SiO₂ concentration of 3.7 weight % and a pH of 2.9 is obtained. On the other hand, 34 g of crystal of diethylenediamine (piperazine, reagent) hexahydrate is dissolved in deionized water and total volume is brought to 190 g, to prepare 8 weight % aqueous solution.

30 g of 8 weight % diethylenediamine aqueous solution is added to 500 g of said obtained active silicic acid aqueous solution while it is stirring and the pH is adjusted to 8.5. The solution is heated to 100° C. and preserved 1 hour, then 9500 g of active silicic acid aqueous solution is added by 9 hours. During adding process, 8 weight % diethylenediamine aqueous solution is added so as to maintain the pH of 9 to 10 while heating (99° C.) is continued. Heating (99° C.) is continued 1 hour after adding process is over, then the solution is matured, and cooled down. In this process, 152 g of 8 weight % diethylenediamine aqueous solution is added. 8.38 kg of colloidal silica whose pH is of 9.35 is obtained.

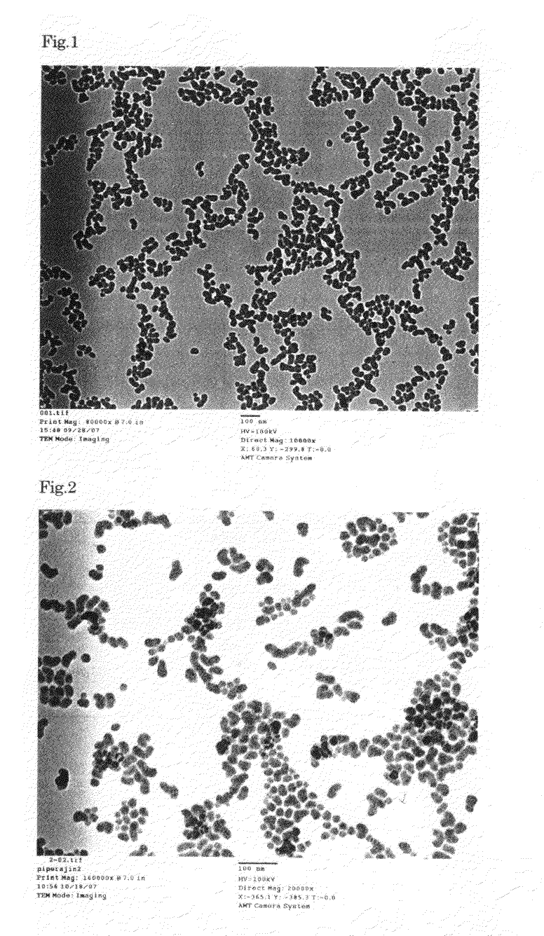

After that, pressure filtration by pump circulation using hollow fiber ultrafilter membrane whose molecular cutoff value is 6000 (MICROZA UF MODULE SIP-1013, product of ASAHI KASEI Corp.) is carried and the solution is concentrated to the silica concentration of 29 weight % and approximately 1218 g of colloidal silica is recovered. pH at 25° C. of this colloidal silica is of 8.9 and particle size measured by BET method is of 24.6 nm, and according to a transmission electron microscope (TEM) observation, it is understood that the colloidal silica forms nonspherical particle cluster, wherein average short axis length is approximately of 25 nm and long axis/short axis ratio is of 1.5 to 7, and average long axis/short axis ratio is of 3. Content of diethylenediamine is of 0.86 weight %, and sodium content and potassium content are 24 ppm and 0 ppm respectively. By use of diethylenediamine, colloidal silica of lower content of alkali metal can be obtained. TEM observation of silica particles is shown in FIG. 2.

### Preparation Example 3

By same method as Preparation Example 1, 40 kg of an active silicic acid aqueous solution having SiO₂ concentration of 3.7 weight % and a pH of 2.9 is obtained. On the other hand, crystal of imidazole (99% reagent) is dissolved in deionized water and 10 weight % imidazole aqueous solution and 2.5 weight % imidazole aqueous solution are prepared.

Then, colloidal particles are grown up by a build up method. That is, 10 weight % imidazole aqueous solution is added to 1000 g of said obtained active silicic acid aqueous solution while it is stirring and the pH is adjusted to 8.0. The solution is heated to 95° C. and preserved 1 hour, then 7080 g of active silicic acid aqueous solution is added by 4.2 hours. During adding process, 2.5 weight % imidazole aqueous solution is added so as to maintain the pH of 8.0 to 8.5, while heating (97° C.) is continued. Heating (97° C.) is continued 1 hour after adding process is over, then the solution is matured, and cooled down.

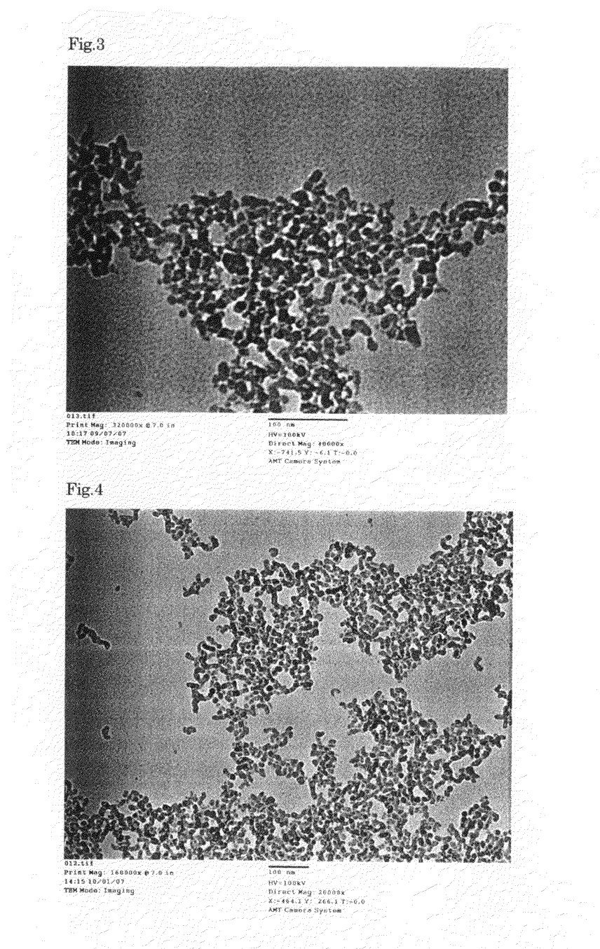

After that, pressure filtration by pump circulation using hollow fiber ultrafilter membrane whose molecular cutoff value is 6000 (MICROZA UF MODULE SIP-1013, product of ASAHI KASEI Corp.) is carried out and the solution is concentrated to have silica concentration of 21 weight % and approximately 1300 g of colloidal silica is recovered. Particle size measured by BET method of this colloidal silica is of 10.0 nm, and according to a transmission electron microscope (TEM) observation, it is understood that the colloidal silica forms nonspherical particle cluster, wherein average short axis length is approximately of 12 nm and long axis/short axis ratio is of 1.5 to 10, and average long axis/short axis ratio is of 3. Content of imidazole is of 0.85 weight % and sodium content and potassium content are 5 ppm and 0 ppm respectively. By use of imidazole, colloidal silica of lower content of alkali metal can be obtained. TEM observation of silica particles is shown in FIG. 3.

### Preparation Example 4

By same method as Preparation Example 1, 40 kg of an active silicic acid aqueous solution having SiO₂ concentration of 3.7 weight % and a pH of 2.9 is obtained. On the other hand, crystal of 2-methylimidazole (99%, reagent) is dissolved in deionized water and 10 weight % methylimidazole aqueous solution and 3.0 weight % methylimidazole aqueous solution are prepared.

Then, colloidal particles are grown up by a build up method. That is, 10 weight % 2-methylmidazole aqueous solution is added to 1000 g of said obtained active silicic acid aqueous solution while it is stirring and the pH is adjusted to 8.0. The solution is heated to 95° C. and preserved 1 hour, then 4500 g of active silicic acid aqueous solution is added by 3.8 hours. During adding process, 3.0 weight % 2-methylmidazole aqueous solution is added so as to maintain the pH of 9.0, while heating (97° C.) is continued. Heating (97° C.) is continued 1 hour after adding process is over, then the solution is matured, and cooled down.

After that, pressure filtration by pump circulation using hollow fiber ultrafilter membrane whose molecular cutoff value is 6000 (MICROZA UF MODULE SIP-1013, product of ASAHI KASEI Corp.) is carried and the solution is concentrated to have silica concentration of 22 weight % and approximately 900 g of colloidal silica is recovered. Particle size measured by BET method of this colloidal silica is of 11.5 nm, and according to a transmission electron microscope (TEM) observation, it is understood that the colloidal silica forms nonspherical particle cluster, wherein average short axis length is approximately of 12 nm and long axis/short axis ratio is of 1.5 to 15, and average long axis/short axis ratio is of 5. Content of 2-methylmidazole is of 0.76 weight % and sodium and potassium content are 8 ppm and 0 ppm respectively. By use of methyl imidazole, colloidal silica of lower content of alkali metal can be obtained. TEM observation of silica particles is shown in FIG. 4.

### Preparation Example 5

By same method as Preparation Example 1, 40 kg of an active silicic acid aqueous solution having SiO₂ concentration of 3.7 weight % and a pH of 2.9 is obtained. On the other hand, liquid of piperidine (reagent) is diluted by deionized water and a 10 weight % piperidine aqueous solution is prepared.

Then, colloidal particles are grown up by a build up method. That is, 20 g of 10 weight % piperidine aqueous solution is added to 500 g of said obtained active silicic acid aqueous solution while it is stirring and the pH is adjusted to 8.5. The solution is heated to 100° C. and preserved 1 hour, then 2500 g of active silicic acid aqueous solution is added by 4 hours. During adding process, 10 weight % piperidine aqueous solution is simultaneously added so as to maintain the pH of 9 to 10 while heating (100° C.) is continued. In this process, 68 g of 10 weight % piperidine aqueous solution is added. According to evaporation of water during adding process, 2660 g of colloidal silica is obtained after cooled down, which has a pH of 9.7. Obtained colloidal silica has a pH of 9.58 at 25° C. and according to a transmission electron microscope (TEM) observation, it is understood that the colloidal silica forms nonspherical particle cluster, wherein average short axis length is approximately of 12 nm and long axis/short axis ratio is of 1.5 to 10.

After that, pressure filtration by pump circulation using hollow fiber ultrafilter membrane whose molecular cutoff value is 6000 (MICROZA UF MODULE SIP-1013, product of ASAHI KASEI Corp.) is carried and the solution is concentrated to have silica concentration of 18 weight % and approximately 550 g of colloidal silica is recovered. Particle size measured by BET method of this colloidal silica is of 11.3 nm, and according to a transmission electron microscope (TEM) observation, it is understood that the colloidal silica forms nonspherical particle cluster, wherein average short axis length is approximately of 12 nm and long axis/short axis ratio is of 1.5 to 10, and average long axis/short axis ratio is of 3.5. Content of piperidine is of 0.96 weight % and sodium and potassium content are 35 ppm and 0 ppm respectively. By use of piperidine, colloidal silica of lower content of alkali metal can be obtained. TEM observation of silica particles is shown in FIG. 5.

### Preparation Example 6

By same method as Preparation Example 1, 40 kg of an active silicic acid aqueous solution having SiO₂ concentration of 3.7 weight % and a pH of 2.9 is obtained. On the other hand, liquid of morpholine (reagent) is diluted by deionized water and a 10 weight % morpholine aqueous solution is prepared.

Then, colloidal particles are grown up by a build up method. That is, 70 g of 10 weight % morpholine aqueous solution is added to 500 g of said obtained active silicic acid aqueous solution while it is stirring and the pH is adjusted to 9.0. The solution is heated to 100° C. and preserved 1 hour, then 8570 g of active silicic acid aqueous solution is added by 4 hours. During adding process, 10 weight % morpholine aqueous solution is simultaneously added so as to maintain the pH of 9 to 10, while heating (100° C.) is continued. Amount of added In this process, 370 g of 10 weight % morpholine aqueous solution is added. According to evaporation of water during adding process, 6200 g of colloidal silica is obtained.

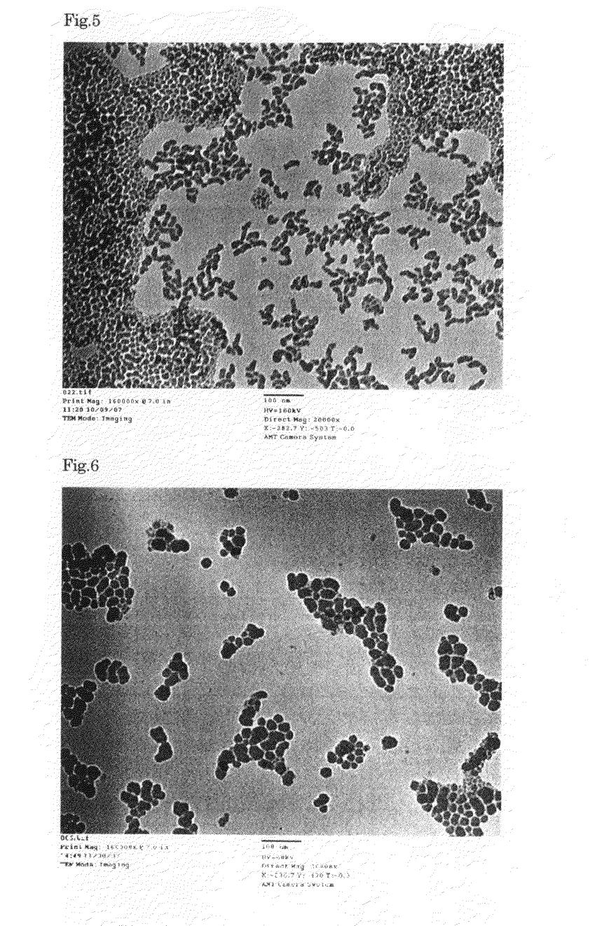

After that, pressure filtration by pump circulation using hollow fiber ultrafilter membrane whose molecular cutoff value is 6000 (MICROZA UF MODULE SIP-1013, product of ASAHI KASEI Corp.) is carried and the solution is concentrated to have silica concentration of 17 weight % and approximately 1900 g of colloidal silica is recovered. Particle size measured by BET method of this colloidal silica is of 14.1 nm, and according to a transmission electron microscope (TEM) observation, it is understood that the colloidal silica forms nonspherical particle cluster, wherein average short axis length is approximately of 15 nm and long axis/short axis ratio is of 1.5 to 4, and average long axis/short axis ratio is of 2. Content of morpholine is of 0.81 weight % and sodium and potassium content are respectively 45 ppm and 0 ppm. By use of morpholine, colloidal silica of lower content of alkali metal can be obtained. TEM observation of silica particles is shown in FIG. 6.

### Preparation Example 7

By same method as Preparation Example 1, 40 kg of an active silicic acid aqueous solution having SiO₂ concentration of 3.7 weight % and a pH of 2.9 is obtained. On the other hand, crystal of L-arginine (reagent) is dissolved in deionized water and a 10 weight % aqueous solution is prepared.

Then, colloidal particles are grown up by a build up method. That is, 50 g of 10 weight % arginine aqueous solution is added to 500 g of said obtained active silicic acid aqueous solution while it is stirring and the pH is adjusted to 8.5. The solution is heated to 100° C. and preserved 1 hour, then 9500 g of active silicic acid aqueous solution is added by 4 hours. During adding process, 10 weight % arginine aqueous solution is simultaneously added so as to maintain the pH of 9 to 10, while heating (100° C.) is continued. In this process 112 g of 10 weight % arginine aqueous solution is added. According to evaporation of water during adding process, 7360 g of colloidal silica is obtained. Obtained colloidal silica has a pH 9.09 at 25° C.

After that, pressure filtration by pump circulation using hollow fiber ultrafilter membrane whose molecular cutoff value is 6000 (MICROZA UF MODULE SIP-1013, product of ASAHI KASEI Corp.) is carried out and the solution is concentrated to have silica concentration of 25 weight % and approximately 1470 g of colloidal silica is recovered. Obtained colloidal silica has pH of 8.60 at 25° C. and according to a transmission electron microscope (TEM) observation, it is understood that the colloidal silica forms non-spherical particle cluster, wherein average short axis length is approximately of 12 nm and long axis/short axis ratio is of 1.1 to 4, and average long axis/short axis ratio is of 1.3. Particle size measured by BET method of this colloidal silica is of 11.2 nm. Content of arginine is of 0.63 weight % and sodium content and potassium content are respectively 30 ppm and 0 ppm. By use of morpholine, colloidal silica of lower content of alkali metal can be obtained. TEM observation of silica particles is shown in FIG. 7.

### Preparation Example 8

By same method as Preparation Example 1, 40 kg of an active silicic acid aqueous solution having SiO₂ concentration of 3.7 weight % and a pH of 2.9 is obtained. On the other hand, hydrazine (hydrazine monohydrate; N₂H₄.H₂O reagent) is dissolved in deionized water and a 5.1 weight % aqueous solution and 2.6 weight % aqueous solution are prepared.

Then, colloidal particles are grown up by a build up method. That is, 24 g of 5.1 weight % hydrazine aqueous solution is added to 800 g of said obtained active silicic acid aqueous solution while it is stirring and the pH is adjusted to 8.5. The solution is heated to 100° C. and preserved 1 hour, then 4200 g of active silicic acid aqueous solution is added by 3.8 hours. During adding process, 2.6 weight % hydrazine aqueous solution is added simultaneously so as to maintain the pH of 9.0 to 10, while heating (100° C.) is continued. In this process 0.57 kg of 10 weight % hydrazine aqueous solution is simultaneously added. Obtained colloidal silica has a pH of 9.2 at 25° C. and particle size measured by BET method of this colloidal silica is of 11.9 nm. According to a transmission electron microscope (TEM) observation, it is understood that the colloidal silica forms nonspherical particle cluster, wherein average short axis length is approximately of 12 nm and long axis/short axis ratio is of 1.5 to 15, and average long axis/short axis ratio is of 1.3.

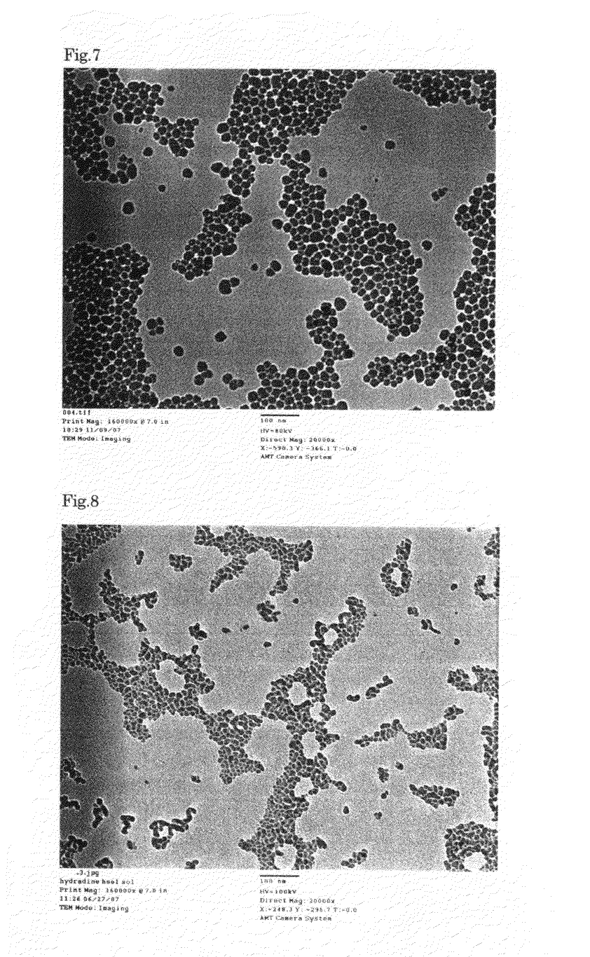

After that, pressure filtration by pump circulation using hollow fiber ultrafilter membrane whose molecular cutoff value is 6000 (MICROZA UF MODULE SIP-1013, product of ASAHI KASEI Corp.) is carried out and the solution is concentrated to have silica concentration of 18 weight % and approximately 970 g of colloidal silica is recovered. Particle size measured by BET method of this colloidal silica is of 11.9 nm, and according to a transmission electron microscope (TEM) observation, it is understood that the colloidal silica forms nonspherical particle cluster, wherein average short axis length is approximately of 12 nm and long axis/short axis ratio is of 1.5 to 10, and average long axis/short axis ratio is of 3.5. Content of hydrazine is of 0.64 weight % and sodium content and potassium content are respectively 6 ppm and 0 ppm. By use of hydrazine, colloidal silica of lower content of alkali metal can be obtained. TEM observation of silica particles is shown in FIG. 8.

### Preparation Example 9

By same method as Preparation Example 1 while using 30 kg of an active silicic acid aqueous solution instead of 40 kg, colloidal particles using ethylene diamine are grown up.

After that, pressure filtration by pump circulation using hollow fiber ultrafilter membrane is carried out and the solution is concentrated to have silica concentration of 27 weight % and approximately 4.1 kg of colloidal silica is recovered. Particle size measured by BET method of this colloidal silica is of 27.4 nm, and according to a transmission electron microscope (TEM) observation, it is understood that the colloidal silica forms nonspherical particle cluster, wherein average short axis length is approximately of 33 nm and long axis/short axis ratio is of 1.5 to 4, and average long axis/short axis ratio is of 3. Content of ethylene diamine is of 0.19 weight % and sodium content and potassium content are respectively 60 ppm and 0 ppm, respectively.

### Preparation Example 10

640 g of colloidal silica having 29 weight % of silica concentration recovered in Preparation Example 2 using diethylenediamine, is added deionized water to make total weight up to 5000 g. 8 weight % diethylenediamine aqueous solution is added while it is stirring and the pH is adjusted to 8.5. The solution is heated to 100° C. and preserved 1 hour, then 10670 g of active silicic acid aqueous solution is added by 9 hours. During adding process, 8 weight % diethylenediamine aqueous solution is simultaneously added so as to maintain the pH of 9 to 10, while heating (99° C.) is continued. Heating (99° C.) is continued 1 hour after adding process is over, then the solution is matured, and cooled down.

After that, pressure filtration by pump circulation using hollow fiber ultrafilter membrane whose molecular cutoff value is 6000 (MICROZA UF MODULE SIP-1013, product of ASAHI KASEI Corp.) is carried out and the solution is concentrated to have silica concentration of 33 weight % and approximately 1750 g of colloidal silica is recovered. Particle size measured by BET method of this colloidal silica is of 36.1 nm, and according to a transmission electron microscope (TEM) observation, it is understood that the colloidal silica forms nonspherical particle cluster, wherein average short axis length is approximately of 41 nm and long axis/short axis ratio is of 1.1 to 2.5, and average long axis/short axis ratio is of 1.6. Content of diethylenediamine is of 0.43 weight % and sodium content is of 19 ppm.

Compositions and properties are summarized in Table 1. Colloidal silica on the market “SILICADOL 40L” and “SILICADOL 40G” in Table 1 are the products of Nippon Chemical Industrial Co., Ltd. These colloidal silica does not contained nitrogen containing basic compound

TABLE 1

| | nitrogen | | silica | short axis | | | |
|---|---|---|---|---|---|---|---|
| Prep. | containing | | contents | length | long/short axis ratio | | BET size |
| Ex. | basic compound | pH | (wt %) | (nm) | range | average | (nm) |
| 1 | ethylenediamine | 9.4 | 23 | 20 | 1.5 to 7 | 5 | 18.6 |
| 2 | diethylenediamine | 8.9 | 29 | 25 | 1.5 to 7 | 3 | 24.6 |
| 3 | imidazole | 8.3 | 21 | 12 | 1.5 to 10 | 3 | 10.0 |
| 4 | methylimidazole | 8.5 | 22 | 12 | 1.5 to 15 | 5 | 11.5 |
| 5 | piperidine | 9.1 | 18 | 12 | 1.5 to 10 | 3.5 | 11.3 |
| 6 | morpholine | 9.2 | 17 | 15 | 1.5 to 4 | 2 | 14.1 |
| 7 | arginine | 8.6 | 25 | 12 | 1.1 to 4 | 1.3 | 11.2 |
| 8 | hydrazine | 8.6 | 18 | 12 | 1.5 to 10 | 3.5 | 11.9 |
| 9 | ethylenediamine | 8.4 | 27 | 33 | 1.5 to 4 | 3 | 27.4 |
| 10 | diethylenediamine | 8.3 | 33 | 41 | 1.1 to 2.5 | 1.6 | 36.1 |

| | | | | | | |
|---|---|---|---|---|---|---|
| product on the market 1 | 9.7 | 40.1 | 21 | 1 | 1.0 | 21 |
| SILICADOL40L | | | | | | |
| product on the market 2 | 9.5 | 40.3 | 50 | 1 | 1.0 | 51.2 |
| SILICADOL40G | | | | | | |

### Example 1 and Comparative Example 1

Hereinafter, 25% tetramethylammoniumhydroxide aqueous solution, 35% tetraethylammonium hydroxide aqueous solution and 48% choline hydroxide aqueous solution are denoted as the followings; “TMAH”, “TEAH” and “Choline”.

In Example 1, deionized water is added to colloidal silica obtained in Preparation Example 1 to 8 to make silica concentration of 2 weight %. Then, TMAH, TEAH or Choline were added to obtain the polishing compositions having pH of 10.2.

In Comparative Example 1, deionized water is added to colloidal silica obtained in Preparation Example 9 to 10 to make silica concentration of 2 weight %. Then, TMAH, TEAH or Choline were added or not added to obtain the polishing compositions having pH of 10.2.

Polishing tests of silicon wafer were performed using these polishing compositions of Examples 1 and Comparative Examples 1. The results were summarized in Table 2.

A machine for polishing a semiconductor wafer used in these tests and polishing conditions therefore were as follows. Single sided polishing machine mentioned below is used, and one surface of a bare wafer is polished.
Polishing machine: SH-24, manufactured by SPEEDFAM Co., Ltd.
Rotational speed of surface plate: 70 RPM
Rotational speed of pressure plate: 50 RPM
Polishing cloth: SUBA600 (manufactured by RODEL NITTA COMPANY)
Load: 150 g/cm²
Flow rate of polishing composition: 100 mL/min
Polishing time: 10 minutes
Wafer: 200 mmΦ bare silicon wafer

Washing after polishing: scrub washing by 1% aqueous ammonia followed by scrub washing by purified water for 30 seconds.

After the completion of the polishing, purified water was supplied on the wafer instead of the polishing composition to wash out the polishing composition. The wafer was then detached from the polishing machine and underwent brush scrub washing using 1% aqueous ammonia and purified water. Spin drying of the wafer was then performed with nitrogen blowing.

The polishing rate was calculated from the difference between the silicon wafer thickness which is measured before and after polishing by ULTRA GAGE (product of ADE Corp.)

The number of particles attached to the surface after washing having a size of 0.10 μm or more was measured with WM-10 (product of TOPCON CORPORATION). The polished surface was evaluated by visually observing the state of haze and pits under a light-collecting lamp.

TABLE 2

| | | | | polishing test | | |
|---|---|---|---|---|---|---|
| | polishing composition | | | polishing | | |
| | Prep. | addition | | rate | number of | polished |
| | Ex. | agent | pH | μm/minute | particles | surface |
| Ex. 1 | 1 | TMAH | 10.2 | 0.23 | <100 | good |
| | 2 | TMAH | 10.2 | 0.20 | <100 | good |
| | 2 | TEAH | 10.2 | 0.19 | <100 | good |
| | 2 | choline | 10.2 | 0.23 | <100 | good |
| | 3 | TMAH | 10.2 | 0.17 | <100 | good |
| | 4 | TEAH | 10.2 | 0.20 | <100 | good |
| | 5 | TEAH | 10.2 | 0.22 | <100 | good |
| | 6 | TMAH | 10.2 | 0.20 | <100 | good |
| | 7 | TMAH | 10.2 | 0.21 | <100 | good |
| | 8 | TMAH | 10.2 | 0.15 | <100 | good |
| Comp. | 9 | none | 8.1 | 0.08 | <100 | scratch |
| Ex. 1 | 9 | choline | 10.2 | 0.22 | <100 | scratch |
| | 10 | TMAH | 10.2 | 0.21 | <100 | scratch |
| | 10 | TEAH | 10.2 | 0.22 | <100 | scratch |
| | P1 (*1) | none | 9.3 | 0.12 | 2860 | good |
| | P1 (*1) | TMAH | 10.2 | 0.19 | 930 | good |
| | P2 (*2) | TEAH | 10.2 | 0.21 | 710 | good |
| | P2 (*2) | choline | 10.2 | 0.23 | 1120 | good |

(*1) P1 is product on the market 1 “SILICADOL 40L”
(*2) P2 is product on the market 2 “SILICADOL 40G”

### Example 2 and Comparative Example 2

Hereinafter, tetramethylammoniumhydroxide aqueous solution and tetramethylammonium hydrogencarbonate are denoted as “TMAH” and “TMAC”

201.7 kg of TMAC aqueous solution was prepared by injecting carbon dioxide into 180 kg of 25% TMAH aqueous solution. According to a chemical analysis, the prepared solution was a 33.1% aqueous solution of TMAC. 163.6 kg of 25% TMAH aqueous solution was added 201.7 kg of TMAC aqueous solution to have the molecular ratio of TMAC/TMAH of 1.1, and 365.3 kg of the pH buffer solution was prepared.

Deionized water is added to colloidal silica obtained in Preparation Example 1 to 8 to make silica concentration of 2 weight %. Then, the amount of TMAC/TMAH buffer solution as stated in Table 3 was added, and polishing compositions were prepared. An amount of buffer solution is the mole amount relative to 1 kg of silica. That is, “0.1 mol/kg-SiO₂” signify “addition of 0.11 mol TMAC and 0.1 mol TMAH relative to 1 kg of silica”.

Polishing tests of silicon wafer were performed using these polishing compositions of Example 2 and Comparative Example 2. The results were summarized in Table 3. The polishing conditions were same with that of Example 1.

TABLE 3

| | polishing composition | | | polishing test | | |
|---|---|---|---|---|---|---|
| | | buffer | | polishing | number | |
| | Prep. | solution | | rate | of | polished |
| | Ex. | mol/kg-SiO₂ | pH | μm/minute | particles | surface |
| Ex. 2 | 1 | 0.1 | 9.7 | 0.23 | <100 | good |
| | 2 | 0.1 | 9.6 | 0.20 | <100 | good |
| | | 0.2 | 9.8 | 0.24 | <100 | good |
| | | 0.4 | 10.0 | 0.26 | <100 | good |
| | 3 | 0.1 | 9.3 | 0.17 | <100 | good |
| | 4 | 0.1 | 9.2 | 0.18 | <100 | good |
| | | 0.3 | 9.8 | 0.22 | <100 | good |
| | | 0.6 | 10.3 | 0.26 | <100 | good |
| | | 1.0 | 10.3 | 0.28 | <100 | good |
| | 5 | 0.1 | 9.7 | 0.22 | <100 | good |
| | | 0.2 | 10.3 | 0.23 | <100 | good |
| | 6 | 0.1 | 9.2 | 0.19 | <100 | good |
| | | 0.2 | 10.3 | 0.21 | <100 | good |
| | 7 | 0.1 | 9.2 | 0.17 | <100 | good |
| | | 0.2 | 9.5 | 0.21 | <100 | good |
| | | 0.4 | 9.8 | 0.25 | <100 | good |
| | 8 | 0.1 | 8.8 | 0.13 | <100 | good |
| | | 0.2 | 10.3 | 0.16 | <100 | good |
| Comp. | P1 (*1) | 0.1 | 10.3 | 0.20 | 3110 | good |
| Ex. 2 | | 0.2 | 10.3 | 0.24 | 1830 | good |

(*1) P1 is product on the market 1 “SILICADOL 40L”

### Examples 3-34 and Comparative Examples 3-23

Deionized water is added to colloidal silica obtained in Preparation Example 2 to 8 to make silica concentration of 2 weight %. Then, the various amount of TMAH was added, and polishing compositions having pH of 8 to 12 were prepared. Polishing tests of silicon wafer were performed using these polishing compositions. The results were summarized in Tables 4 and 5. The polishing conditions were same with Examples 1.

TABLE 4

| | | | | polishing test | |
|---|---|---|---|---|---|
| | polishing composition | | | polishing | |
| | Prep. | addition | | rate | polished |
| | Ex. | agent | pH | μm/minute | surface |
| Comp. Ex. 3 | 2 | none | 8.3 | 0.12 | pits |
| Ex. 3 | | TMAH | 8.7 | 0.17 | good |
| Ex. 4 | | TMAH | 9.4 | 0.19 | good |
| Ex. 5 | | TMAH | 10.2 | 0.20 | good |
| Ex. 6 | | TMAH | 10.8 | 0.22 | good |
| Comp. Ex. 4 | | TMAH | 11.5 | 0.24 | haze |
| Comp. Ex. 5 | | TMAH | 12.1 | 0.27 | haze all over |
| Comp. Ex. 6 | 3 | none | 8.1 | 0.09 | pits, scratch |
| Comp. Ex. 7 | | TMAH | 8.4 | 0.12 | pits |
| Ex. 7 | | TMAH | 9.2 | 0.15 | good |
| Ex. 8 | | TMAH | 9.7 | 0.16 | good |
| Ex. 9 | | TMAH | 10.2 | 0.17 | good |
| Ex. 10 | | TMAH | 11.0 | 0.19 | good |
| Comp. Ex. 8 | | TMAH | 11.4 | 0.21 | haze |
| Comp. Ex. 9 | | TMAH | 12.3 | 0.25 | haze |
| Comp. Ex. 10 | 4 | none | 8.2 | 0.10 | pits, scratch |
| Ex. 11 | | TMAH | 8.5 | 0.12 | good |
| Ex. 12 | | TMAH | 9.0 | 0.17 | good |
| Ex. 13 | | TMAH | 9.6 | 0.19 | good |
| Ex. 14 | | TMAH | 10.2 | 0.20 | good |
| Ex. 15 | | TMAH | 10.8 | 0.22 | good |
| Comp. Ex. 11 | | TMAH | 11.4 | 0.23 | haze |
| Comp. Ex. 12 | | TMAH | 12.3 | 0.25 | haze |

TABLE 5

| | | | | polishing test | |
|---|---|---|---|---|---|
| | polishing composition | | | polishing | |
| | Prep. | addition | | rate | polished |
| | Ex. | agent | pH | μm/minute | surface |
| Comp. Ex. 13 | 5 | none | 8.8 | 0.17 | good |
| Ex. 17 | | TMAH | 9.0 | 0.19 | good |
| Ex. 18 | | TMAH | 9.5 | 0.21 | good |
| Ex. 19 | | TMAH | 10.2 | 0.22 | good |
| Ex. 20 | | TMAH | 10.6 | 0.23 | good |
| Comp. Ex. 14 | | TMAH | 11.3 | 0.24 | haze |
| Comp. Ex. 15 | | TMAH | 12.0 | 0.25 | haze |
| Ex. 21 | 6 | TMAH | 9.0 | 0.16 | good |
| Ex. 22 | | TMAH | 9.5 | 0.18 | good |
| Ex. 23 | | TMAH | 10.2 | 0.20 | good |
| Ex. 24 | | TMAH | 10.6 | 0.21 | good |
| Comp. Ex. 16 | | TMAH | 11.3 | 0.23 | haze |
| Comp. Ex. 17 | | TMAH | 12.0 | 0.25 | haze |
| Comp. Ex. 18 | 7 | none | 8.4 | 0.07 | pits, scratch |
| Ex. 25 | | TMAH | 8.7 | 0.12 | good |
| Ex. 26 | | TMAH | 9.0 | 0.14 | good |
| Ex. 27 | | TMAH | 9.6 | 0.18 | good |
| Ex. 28 | | TMAH | 10.2 | 0.21 | good |
| Ex. 29 | | TMAH | 10.6 | 0.22 | good |
| Comp. Ex. 19 | | TMAH | 11.3 | 0.24 | haze |
| Comp. Ex. 20 | | TMAH | 12.0 | 0.27 | haze |
| Comp. Ex. 21 | 8 | none | 8.4 | 0.05 | pits, scratch |
| Ex. 30 | | TMAH | 8.6 | 0.08 | good |
| Ex. 31 | | TMAH | 9.0 | 0.10 | good |
| Ex. 32 | | TMAH | 9.5 | 0.12 | good |
| Ex. 33 | | TMAH | 10.2 | 0.15 | good |
| Ex. 34 | | TMAH | 10.5 | 0.16 | good |
| Comp. Ex. 22 | | TMAH | 11.2 | 0.19 | haze |
| Comp. Ex. 23 | | TMAH | 12.0 | 0.21 | haze |

### Examples 35-39 and Comparative Examples 24-27

Deionized water is added to colloidal silica obtained in Preparation Example 2 to 6 and product on the market to make silica concentration of 4 weight %. Addition agent was added or not added, and polishing compositions were prepared. The buffer solution using in this example is prepared in Example 2. Edge polishing tests of silicon wafer were performed using these polishing compositions. Successively 300 wafer pieces were polished while the polishing compositions were repeatedly circulated. The polishing rate was measured at 5^{th}, 50^{th}, 100^{th}, 200^{th}, and 300^{th} run in run of 300 times. The polishing rate was calculated from the difference of weight of wafer which measured before and after polishing. The results were summarized in Table 6.

A machine for polishing a semiconductor wafer used in these tests and polishing conditions thereof were as follows:
Polishing machine: EPD-200X, manufactured by SPEEDFAM Co., Ltd.
Rotational speed of surface plate: 2000 RPM
Polishing cloth: SUBA400 (manufactured by NITTA HAAS INCORPORATED)
Load: 40 N/unit
Flow rate of polishing composition: 3 L/min
Polishing time: 60 second
Wafer: 200 mmΦ bare silicon wafer

TABLE 6

| | polishing composition | | polishing rate | | | | |
|---|---|---|---|---|---|---|---|
| | colloidal | addition | mg/minute | | | | |
| | silica | agent | run number | | | | |
| | conc. wt. % | mol/kg-SiO₂ | 5 | 50 | 100 | 200 | 300 |
| Ex. 35 | Prep. | buffer | 17.2 | 17.6 | 17.3 | 17.2 | 17.4 |
| | Ex. 2 | solution | | | | | |
| | 4.0 | 0.2 | | | | | |
| Ex. 36 | Prep. | buffer | 18.3 | 18.0 | 18.1 | 18.0 | 17.8 |
| | Ex. 5 | solution | | | | | |
| | 4.0 | 0.2 | | | | | |
| Ex. 37 | Prep. | buffer | 16.8 | 17.1 | 16.9 | 16.8 | 16.8 |
| | Ex. 6 | solution | | | | | |
| | 4.0 | 0.2 | | | | | |
| Ex. 38 | Prep. | TMAH | 19.5 | 18.9 | 18.6 | 18.2 | 17.8 |
| | Ex. 3 | 0.2 | | | | | |
| | 4.0 | | | | | | |
| Ex. 39 | Prep. | TMAH | 18.1 | 17.4 | 16.9 | 16.5 | 16.2 |
| | Ex. 4 | 0.2 | | | | | |
| | 4.0 | | | | | | |
| Comp. | P1 (*1) | buffer | 11.8 | 11.6 | 11.4 | 11.4 | 11.4 |
| Ex. 24 | 4.0 | solution | | | | | |
| | | 0.2 | | | | | |
| Comp. | P1 (*1) | TMAH | 12.9 | 12.2 | 11.8 | 11.3 | 11.0 |
| Ex. 25 | 4.0 | 0.2 | | | | | |
| Comp. | Prep. | none | 7.3 | 7.3 | 7.1 | 6.9 | 6.2 |
| Ex. 26 | Ex. 2 | | | | | | |
| | 4.0 | | | | | | |
| Comp. | P1 (*1) | none | 7.5 | 7.2 | 6.8 | 6.3 | 5.8 |
| Ex. 27 | 4.0 | | | | | | |

(*1) P1 is product on the market 1 “SILICADOL 40L”

What is claim:

1. A polishing composition for semiconductor wafer polishing comprising, colloidal silica prepared from an active silicic acid aqueous solution obtained by removal of alkali from alkali silicate and at least one nitrogen containing basic compound selected from a group consisting of ethylenediamine, diethylenediamine, imidazole, methylimidazole, piperidine, morpholine, arginine, and hydrazine, wherein pH of the colloidal silica is of 8.5 to 11.0 at 25° C. by containing quaternary ammonium hydroxide.

2. The polishing composition for semiconductor wafer polishing of claim 1 further comprising, a buffer solution composed of mixing weak acid which have a logarithm of a reciprocal of acid dissociation constant of 8.0 to 12.0 at 25° C. and quaternary ammonium hydroxide, wherein said polishing composition for semiconductor wafer displays pH buffering action in the pH range of 8.5 to 11.0 at 25° C.

3. The polishing composition for semiconductor wafer polishing of claim 1, wherein said quaternary ammonium hydroxide is selected from a group consisting of tetramethylammonium hydroxide, tetraethyl ammonium hydroxide or choline hydroxide.

4. The polishing composition for semiconductor wafer polishing of claim 2, wherein an anion constituting the weak acid is a carbonate ion and/or a hydrogen carbonate ion.

5. The colloidal silica for semiconductor wafer polishing of claim 1, wherein average short axis length of said silica particles is of 10 to 30 nm, long axis/short axis ratio is of 1.1 to 20, and average long axis/short axis ratio is of 1.2 to 7, by electron microscopic observation method.

6. The colloidal silica for semiconductor wafer polishing of claim 1, wherein average particle diameter of silica particles is of 10 to 50 nm, by nitrogen adsorption BET method.

7. The polishing composition for semiconductor wafer polishing of claim 1, wherein said colloidal silica is an aqueous solution whose concentration of silica to entire colloidal silica solution is of 2 to 50 weight %.

8. The polishing composition for semiconductor wafer polishing of claim 1, wherein said colloidal silica is an aqueous solution whose concentration of alkali metal to entire colloidal silica solution is less than 100 ppm.
